(19) United States
(12) Patent Application Publication
(10) Pub. No.: US 2011/0293286 A1
(43) Pub. Date: Dec. 1, 2011

(54) Method for optical data transmission using existing indicator or illumination lamp

(75) Inventor: Samuel Carl Colwell, Randolph, VT (US)

(73) Assignee: LEDdynamics, Inc.

(21) Appl. No.: 12/800,966

(22) Filed: May 25, 2010

(51) Int. Cl. H04B 10/00

(52) U.S. Cl. 398/140

(57) ABSTRACT

A method is described for the transmission of data using LEDs or other light sources without interfering with the standard use of the lighting source.

### CROSS REFERENCE TO RELATED APPLICATIONS

This application claims the benefit of provisional patent application Ser. No. 61/216,143.

### BACKGROUND

The concept described herein relates to the optical transmission of data, specifically to a method that can be used to transmit data using LEDs (light emitting diodes), or other applicable light sources, without interfering with the standard use of the light source.

### DESCRIPTION OF PRIOR ART

Previous methods of transmitting data using a beam of light as the communication medium fall into one of two categories. In one category, there was no concern as to the degradation of the light source from its intended use or visibility of the effect of data transmission. In the second category, where visibility of the transmission was of concern, either non-visible light, infra-red or ultraviolet, was used or very short bursts of intensity modulated data were imposed upon the light beams at speeds not discernible by the eye. In this category were also methods by which only a few from an array of many LEDs were modulated, thus preventing visibility by making the variation in total light output a small percentage of the total.

### BACKGROUND OF PRESENT METHOD

This method allows data to be transmitted by a light source without interfering with the normal function of the device such as as an indicator or as an illuminating device.

This method allows existing products using LEDs as indicators or as sources of illumination to be readily modified, at low cost, to transmit data.

This method allows the transmission of data using visible light without the effects of data transmission being visible to the eye even if the source of the visible light is a single LED or other light source.

This method permits the use of various detectors such as photo-diodes, photo-transistors, silicon solar cells, and cadmium sulphide photocells.

While this method is intended to work with LEDs, it can be used with any light source capable of being turned on and off, or have its intensity modulated, at rates greater than 60 times per second.

### DRAWING FIGURES

FIG. 1 shows a schematic diagram of a typical implementation with a constant current supply.

FIG. 2 shows a schematic diagram of a typical implementation with a constant voltage supply.

FIG. 3 shows a schematic diagram of an implementation where the method is used with one of a multiplicity of light emitting devices.

FIG. 4 shows a schematic diagram of an alternate current shunting device.

FIG. 5 shows a schematic diagram for shunting a portion of the current through the light emitting device.

### DESCRIPTION

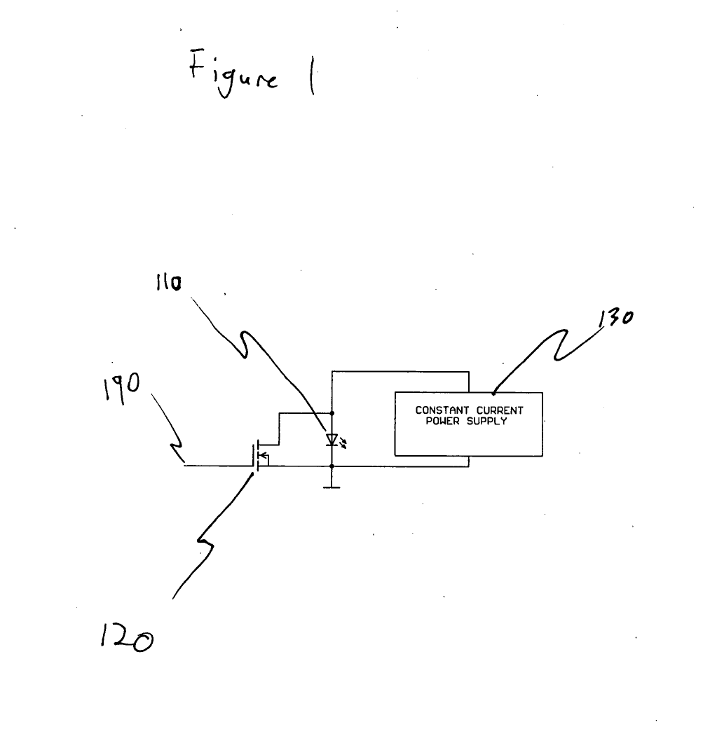

### FIGS. 1 to 5

FIG. 1 shows a typical circuit used to implement the transmission method. This circuit consists of constant current power supply 130 connected to LED 110. MOSFET 120 is connected across LED 110 and is connected to signal input 190.

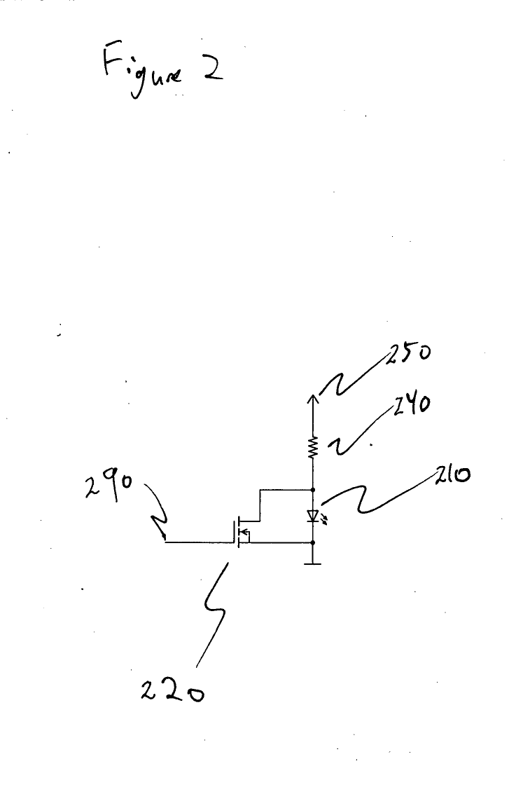

FIG. 2 shows an implementation used with constant voltage power supply 250. Constant voltage power supply 250 is connected to resistor 240. The other side of resistor 240 is connected to LED 210. MOSFET 220 is connected across LED 210 and is connected to signal input 290.

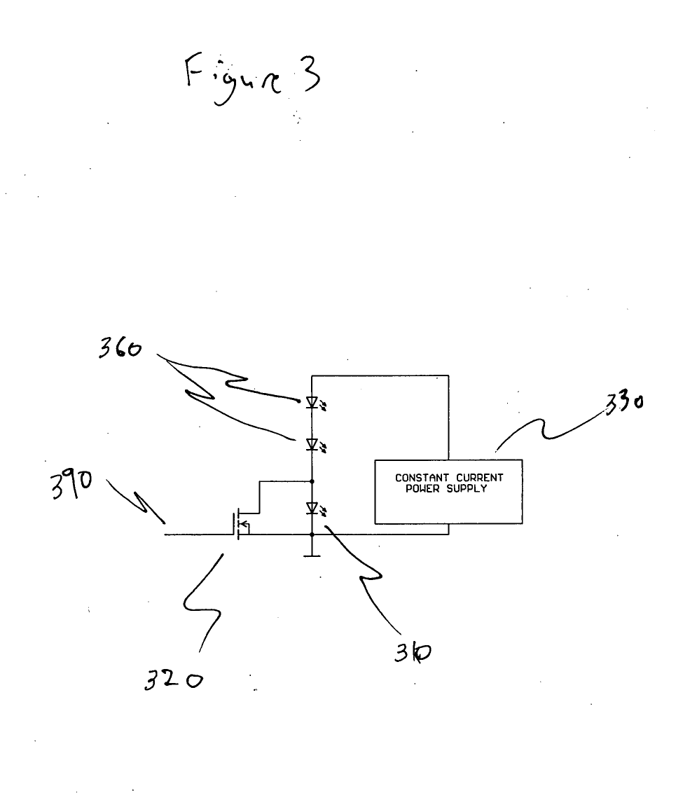

FIG. 3 shows an implementation with constant current power supply 330 connected to a multiplicity of additional LEDs 360 connected in series with LED 310. MOSFET 320 is connected across LED 310 and is connected to signal input 390.

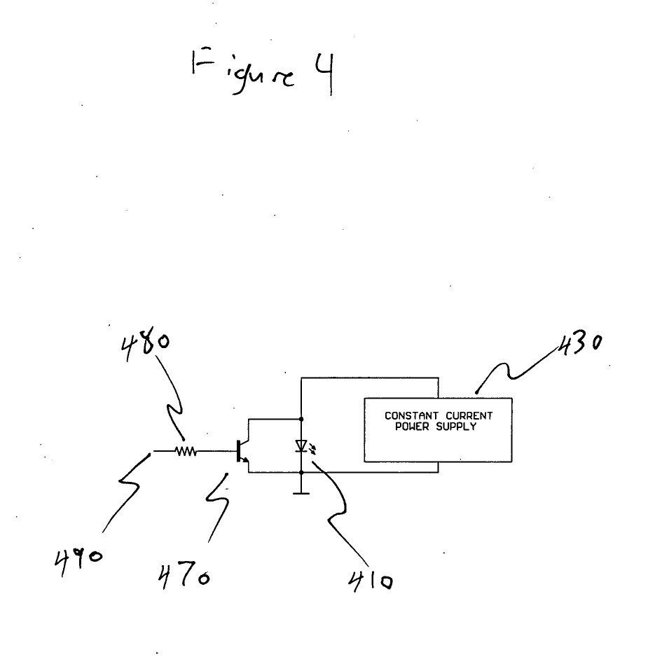

FIG. 4 shows an implementation using bipolar transistor 470. Constant current power supply supply 430 is connected to LED 410. Bipolar transistor 470 is connected across LED 410. One side of resistor 480 is connected to input signal 490. The opposite end of input resistor 480 is connected to bipolar transistor 470.

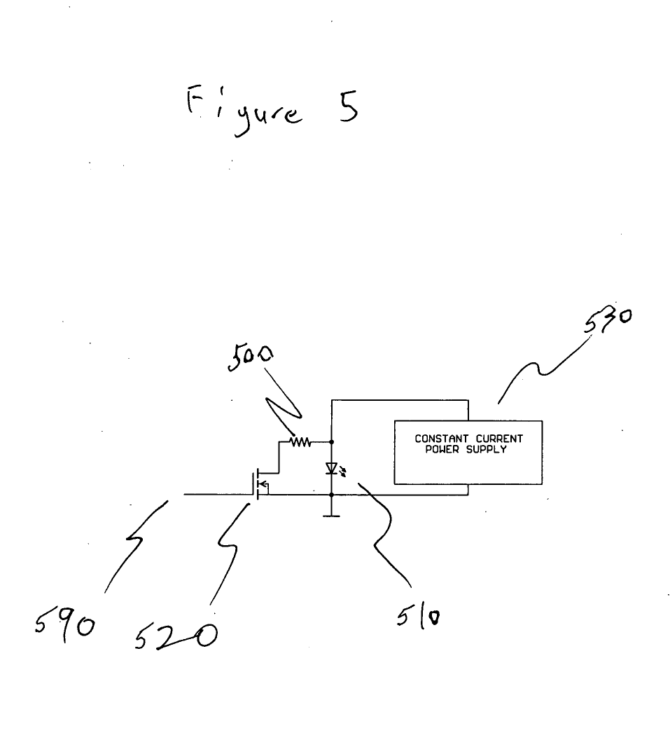

FIG. 5 shows an implementation where a portion of the current through LED 510 is shunted. Constant current supply 530 is connected to LED 510. One side of shunt resistor 500 is connected to MOSFET 520. The opposite side of shunt resistor 500 is connected to to LED 510. The MOSFET 520 is connected to signal input 590.

### Operation—FIGS. 1 to 5

FIG. 1 shows a typical circuit implementation of the method. With no signal present at signal input 190, MOSFET 120 will not conduct current. The current provided by constant current supply 130 will be conducted through LED 110 causing it to turn on and emit light. With a signal applied to signal input 190, MOSFET 120 will shunt the current normally being conducted through LED 110 causing LED 110 to turn off.

By applying a signal having a low, fixed duty cycle, e.g., 1%, at a frequency of 60 Hz or higher, to signal input 190, data can be transmitted by LED 110 without the effect being visible to the human eye. The light output of LED 110 will be lessened in proportion the duty cycle. With a low duty cycle, the slight difference would be indistinguishable. Several commonly used data encoding schemes, such as Frequency Shift Keying, Manchester Encoding, Phase Shift Keying, Pulse Position Modulation, etc., could be used provided that the encoding scheme creates a signal with a low, fixed duty cycle signal.

FIG. 2 shows a typical implementation where LED 210 is used as a power indicator. LED 210 is driven by constant voltage supply 250 through resistor 240. MOSFET 220 will shunt the current normally conducted by LED 210 when a signal is applied to signal input 290. The current shunted by MOSFET 220 will be higher than the normal operating current of LED 210 because the entire voltage of constant voltage supply 250 will appear across resistor 240 when MOSFET 220 is conducting. When MOSFET 220 is not conducting, the voltage across resistor 240 will be equal to the output of constant voltage supply 250 minus the forward voltage drop of LED 210.

By applying a signal having a low, fixed duty cycle, e.g., 1%, at a frequency of 60 Hz or higher, to signal input 290, data can be transmitted by LED 210 without the effect being visible to the human eye. The light output of LED 210 will be lessened in proportion the duty cycle. With a low duty cycle, the slight difference would be indistinguishable. Several commonly used data encoding schemes, such as Frequency Shift Keying, Manchester Encoding, Phase Shift Keying, Pulse Position Modulation, etc., could be used provided that the encoding scheme creates a signal with a low, fixed duty cycle signal.

FIG. 3 shows an implementation with data transmission by LED 310 when it is connected in series with one or a multiplicity of additional LEDs 360. The current from constant current supply 330 will normally be conducted through all of the series-connected LEDs. The current can be shunted from LED 310 without changing the current through the additional LEDs 360. Thus, only the light output from LED 310 would be lessened.

By applying a signal having a low, fixed duty cycle, e.g., 1%, at a frequency of 60 Hz or higher, to signal input 390, data can be transmitted by LED 310 without the effect being visible to the human eye. The light output of LED 310 will be lessened in proportion the duty cycle. With a low duty cycle, the slight difference would be indistinguishable. Several commonly used data encoding schemes, such as Frequency Shift Keying, Manchester Encoding, Phase Shift Keying, Pulse Position Modulation, etc., could be used provided that the encoding scheme creates a signal with a low, fixed duty cycle signal.

FIG. 4 show an implementation where bipolar transistor 470 is used as the shunting device. When a signal is applied to signal input 490, current is applied to the base of bipolar transistor 470 through resistor 480. This will cause the current delivered by constant current supply 430 to be shunted away from LED 410. Input resistor 480 serves to limit the current load that can be placed on signal input 490.

By applying a signal having a low, fixed duty cycle, e.g., 1%, at a frequency of 60 Hz or higher, to signal input 490, data can be transmitted by LED 410 without the effect being visible to the human eye. The light output of LED 410 will be lessened in proportion the duty cycle. With a low duty cycle, the slight difference would be indistinguishable. Several commonly used data encoding schemes, such as Frequency Shift Keying, Manchester Encoding, Phase Shift Keying, Pulse Position Modulation, etc., could be used provided that the encoding scheme creates a signal with a low, fixed duty cycle signal.

FIG. 5 shows an implementation where only a portion of the current is shunted away from LED 510. This is accomplished by placing shunt resistor 500 between MOSFET 520 and LED 510. This implementation allows the use of a higher duty cycle with the same total lessening of output from LED 510 because LED 510 is never turned fully off.

By applying a signal having a relatively low, fixed duty cycle, e.g., 10%, at a frequency of 60 Hz or higher, to signal input 590, data can be transmitted by LED 510 without the effect being visible to the human eye. The light output of LED 510 will be lessened in proportion the duty cycle and the amount of current shunted away. With a duty cycle of 10% and a shunting away of 90% for example, the slight difference would be indistinguishable. Several commonly used data encoding schemes, such as Frequency Shift Keying, Manchester Encoding, Phase Shift Keying, Pulse Position Modulation, etc., could be used provided that the encoding scheme creates a signal with a low, fixed duty cycle signal.

One exemplary embodiment of the method would be the incorporation of the device in an LED-based unit meant to provide general illumination. By use of one or more appropriate sensors, signal conditioning circuitry and data formatting circuitry, important parameters such as power consumption, operating temperature, operating time, etc., could be transmitted on a continuous basis without degrading the primary purpose of the lighting unit. Any of the implementations shown in FIGS. 1 through 5 can be used by connecting the output of the data formatting circuitry to the designated signal input points. This embodiment could be used to provide non-intrusive measurement of important parameters during the development stage of such lighting units as well as long term measurements to determine operating costs, operating life, and other factors which may be deemed useful. The types of sensors, signal conditioning circuits, and data formatting circuitry are well known to a person of ordinary skill in the art.

Another exemplary embodiment would be the incorporation of the device in equipment provided with a power indicator LED. By use of one or more appropriate sensors, signal conditioning circuitry and data formatting circuitry, important data related to proper operation etc., could be transmitted on a continuous basis without degrading the primary purpose of the indicator. Any of the implementations shown in FIGS. 1 through 5 can be used by connecting the output of the data formatting circuitry to the designated signal input points. This embodiment could be used to provide non-intrusive measurement of important parameters during the development stage of such equipment as well as long term measurements to determine operation and use within warranty limits or other factors deemed important. The types of sensors, signal conditioning circuits, and data formatting circuitry are well known to a person of ordinary skill in the art.

Another exemplary embodiment would be the incorporation of the device on printed circuit cards containing board mounted LED indicators. An LED used to indicate correct operating voltage, for example, could be used to transmit additional critical operating parameters without degrading the original purpose of the indicator. Any of the implementations shown in FIGS. 1 through 5 can be used by connecting the output of the data formatting circuitry to the designated signal input points. The types of circuits capable of collecting and formatting the data are well known to a person of ordinary skill in the art.

### SUMMARY, RAMIFICATIONS, AND SCOPE

Accordingly, the reader will see that the means described for achieving the optical transmission of data has the following advantages:
The described method can be readily used with an existing light source.
The described method is readily implemented when used in conjunction with either a constant voltage or a constant current power source as commonly used in LED systems.
The described method does not noticeably interfere with the normal operation of the light source.
The described method provides an non-intrusive means of collecting and transmitting data related to important operating parameters
The described method can transmit data continuously without being visible to an observer.
The described method can be incorporated at low cost.

Although the description above refers to MOSFETs and bipolar transistors, it will be obvious to one skilled in the art that these are not the only electronic devices capable of shunting current away from a light emitting source. Any current shunting device that can turn on and off faster than 60 Hz could be used. Further, light emitting sources other than LEDs may be used when such devices are capable of being turned on and off at rates greater than 60 Hz.

Thus, the scope of the method should be determined by the appended claims and their legal equivalents rather than by the examples given.

We claim:

1. A method which allows data to be transmitted optically through an LED or other light source without interfering with the normal use of the light source, comprising
a current shunting device;
a control signal input for the data stream.

2. The method of claim 1 for making the data transmission not visually detectable.

3. The method of claim 1 for making the optical data detectable by a wide range of available photo detectors.

4. The method of claim 1 using a constant voltage power source.

5. The method of claim 1 using a constant current power source.

6. The method of claim 1 using MOSFET transistor as a shunt switching device.

7. The method of claim 1, using a bipolar transistor as a shunt switching device.

8. The method of claim 1 shunting a single LED.

9. The method of claim 1 shunting one of a multiplicity of LEDs.

10. The method of claim 1 transmitting data using a protocol that provides a fixed percentage on/off ration (duty cycle), such as Frequency Shift Keying, Manchester Encoding, Phase Shift Keying, Pulse Position Modulation, etc.

11. The method of claim 1 added to an existing product that uses an LED or other light emitting source as either an indicator or illumination source.

12. The method of claim 1 used to transmit data using a light emitting source which operates normally as a power indicator.

13. The method of claim 1 used to transmit data using a light emitting source which operated normally as a source of illumination.

14. The method of claim 1 used to transmit data using a light emitting source which normally operates as a light source for a back-lit LCD screen.
